(19) United States
(12) Patent Application Publication
(10) Pub. No.: US 2010/0018926 A1
(43) Pub. Date: Jan. 28, 2010

(54) Mixed Matrix Membranes Containing Ion-Exchanged Molecular Sieves

(76) Inventors: Chunqing Liu, Schamburg, IL (US); Jaime G. Moscoso, Mount Prospect, IL (US); Raisa Serbayeva, Skokie, IL (US); Stephen T. Wilson, Libertyville, IL (US); David A. Lesch, Hoffman Estates, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/145,559

(22) Filed: Jun. 25, 2008

(51) Int. Cl. B01D 61/02; B01D 61/00; B01D 53/22; B01D 53/48; B01D 53/54; C08K 3/34; C08L 85/00

(52) U.S. Cl. 210/655; 95/54; 210/652; 210/653; 210/654; 95/51; 95/45; 95/52; 95/49; 95/47; 524/450; 525/389; 525/185

(57) ABSTRACT

The present invention discloses mixed matrix membranes (MMMs) comprising ion-exchanged molecular sieves such as UZM-5 zeolite ion-exchanged with Li⁺ cation (Li-UZM-5) and a continuous polymer matrix and methods for making and using these membranes. These MMMs, comprising ion-exchanged molecular sieves, in the form of symmetric dense films, asymmetric flat sheets, asymmetric hollow fibers, or thin-film composites, have exhibited simultaneously increased selectivity and permeability (or permeance) over polymer-only membranes and the mixed matrix membranes made from molecular sieves that have not been ion exchanged for gas separations. These MMMs are suitable for a variety of liquid, gas, and vapor separations such as desalination of water by reverse osmosis, deep desulfurization of gasoline and diesel fuels, ethanol/water separations, pervaporation dehydration of aqueous/organic mixtures, CO₂/CH₄, CO₂/N₂, H₂/CH₄, O₂/N₂, olefin/paraffin, iso/normal paraffins separations, and other light gas mixture separations.

### BACKGROUND OF THE INVENTION

This invention relates to mixed matrix membranes containing ion-exchanged molecular sieves. More particularly, this invention relates to the use of certain ion-exchanged molecular sieves such as UZM-5.

Currently produced commercial cellulose acetate (CA) polymer membranes for natural gas upgrading must be improved to meet the need for higher performance membranes. It is highly desirable to provide an alternate cost-effective new membrane with higher selectivity and permeability than CA membrane for CO₂/CH₄ and other gas and vapor separations.

Gas separation processes with membranes have undergone a major evolution since the introduction of the first membrane-based industrial hydrogen separation process about two decades ago. The design of new materials and efficient methods will further advance the membrane gas separation processes within the next decade.

The gas transport properties of many glassy and rubbery polymers have been measured as part of the search for materials with high permeability and high selectivity for potential use as gas separation membranes. Unfortunately, an important limitation in the development of new membranes for gas separation applications is a well-known trade-off between permeability and selectivity of polymers. By comparing the data of hundreds of different polymers, Robeson demonstrated that selectivity and permeability seem to be inseparably linked to one another, in a relation where selectivity increases as permeability decreases and vice versa.

Despite concentrated efforts to tailor polymer structure to improve separation properties, current polymeric membrane materials have seemingly reached a limit in the trade-off between productivity and selectivity. For example, many polyimide and polyetherimide glassy polymers such as Ultem® 1000 have much higher intrinsic CO₂/CH₄ selectivities (α_{CO2/CH4}) (˜30 at 50° C. and 690 kPa (100 psig) pure gas tests) than that of cellulose acetate (˜22), which are more attractive for practical gas separation applications. These polymers, however, do not have outstanding permeabilities attractive for commercialization compared to current commercial cellulose acetate membrane products, in agreement with the trade-off relationship reported by Robeson. On the other hand, some inorganic membranes such as ZSM-58 zeolite and carbon molecular sieve membranes offer much higher permeability and selectivity than polymeric membranes for separations, but are expensive and difficult for large-scale manufacture. Therefore, it is highly desirable to provide an alternate cost-effective membrane with improved separation properties and in a position above the trade-off curves between permeability and selectivity.

Based on the need for more efficient membranes than polymer and inorganic membranes, a new type of membrane, mixed matrix membranes (MMMs), has been developed recently. A mixed matrix membrane is an organic-inorganic hybrid membrane containing inorganic fillers such as molecular sieves dispersed in a polymer matrix.

Mixed matrix membranes have the potential to achieve higher selectivity with equal or greater permeability compared to existing polymer membranes, while maintaining their advantages such as low cost and easy processability. Much of the research conducted to date on mixed matrix membranes has focused on the combination of a dispersed molecular sieving phase, such as molecular sieves or carbon molecular sieves, with an easily processed continuous polymer matrix. For example, see U.S. Pat. No. 6,626,980; US 2005/0268782; US 2007/0022877; and U.S. Pat. No. 7,166,146. The sieving phase in a molecular sieve/polymer mixed matrix scenario can have a selectivity that is significantly higher than the pure polymer. Therefore, in theory, the addition of a small volume fraction of molecular sieves to the polymer matrix will increase the overall separation efficiency significantly. Typical molecular sieve phases in MMMs include various molecular sieves, carbon molecular sieves, and traditional silica. Many organic polymers, including cellulose acetate, polyvinyl acetate, polyetherimide (commercially Ultem®), polysulfone (commercial Udel®), polydimethylsiloxane, polyethersulfone, and several polyimides (including commercial Matrimid®), have been used as the continuous phase in MMMs.

US 2005/0139065 A1 to Miller et al., entitled “Mixed matrix membranes with low silica-to-alumina ratio molecular sieves and methods for making and using the membranes”, reports the incorporation of low silica-to-alumina (Si/Al) ratio molecular sieves into a polymer membrane with a Si/Al molar ratio of the molecular sieves preferably less than 1.0. Miller et al. claim that when the low Si/Al ratio molecular sieves are properly interspersed with a continuous polymer matrix, the MMM ideally will exhibit improved gas separation performance even without functionalizing the surface of the molecular sieves using organosilicon coupling agent. This invention, however, eliminates the use of many high Si/Al ratio molecular sieves with suitable micropore size and excellent molecular sieving separation property in MMMs. Furthermore, our experimental results showed that some of the low Si/Al ratio, high acidity silicoaluminophosphate (SAPO) molecular sieves (e.g., SAPO-34 with Si/Al ratio of 0.14) reacted with and therefore partially decomposed some polymer matrices (e.g., polyimides and polyamides). The MMMs made from these low Si/Al ratio, high acidity SAPO molecular sieves showed no CO₂/CH₄ selectivity improvement for CO₂/CH₄ gas separation compared to the membranes made from the corresponding polymer matrices.

Despite all the research efforts, there is still a need for additional choices of molecular sieves for making molecular sieve/polymer MMMs with significantly improved separation performance.

The current invention involves a new type of mixed matrix membranes comprising ion-exchanged molecular sieves such as UZM-5 zeolite ion-exchanged with Li⁺ cation (Li-UZM-5) and a continuous polymer matrix.

### SUMMARY OF THE INVENTION

This invention pertains to mixed matrix membranes comprising ion-exchanged molecular sieves such as UZM-5 zeolites ion-exchanged with Li⁺ cation (Li-UZM-5) and a continuous polymer matrix and methods for making and using these membranes.

After going through an ion exchange treatment, the acid sites (H⁺ sites) in the molecular sieves were successfully replaced by metal cations, such as Li⁺, K⁺, Ag⁺ and Cu²⁺. The separation performance of the mixed matrix membranes made from these ion-exchanged molecular sieves is significantly improved compared with that of the polymer-only membranes and the mixed matrix membranes made from unexchanged molecular sieves.

The present invention provides a method of making mixed matrix membranes containing ion-exchanged molecular sieves. The method comprises first dispersing the ion-exchanged molecular sieve particles in a mixture of two or more organic solvents by ultrasonic mixing and/or mechanical stirring or another method to form a molecular sieve slurry; then dissolving a suitable polymer in the molecular sieve slurry to functionalize the surface of the ion-exchanged molecular sieve particles; dissolving a polymer that serves as a continuous polymer matrix in the polymer functionalized ion-exchanged molecular sieve slurry to form a stable ion-exchanged molecular sieve/polymer suspension; and as the last step, fabricating a mixed matrix membrane in a form of a symmetric dense film, an asymmetric flat sheet, an asymmetric hollow fiber, or a thin film composite using the stable ion-exchanged molecular sieve/polymer suspension.

The mixed matrix membrane prepared by the present invention comprises uniformly dispersed polymer-functionalized ion-exchanged molecular sieve particles throughout the continuous polymer matrix. The continuous polymer matrix is selected from a glassy polymer such as a polyimide. The polymer used to functionalize the surface of the ion-exchanged molecular sieve particles is selected from a polymer different from the polymer matrix. The molecular sieve materials in the mixed matrix membranes provided in this invention are crystalline microporous aluminosilicates such as UZM-25 (described in US 20050065016A1, incorporated by reference herein in its entirety), UZM-5 (described in U.S. Pat. No. 6,613,302, incorporated by reference herein in its entirety) and UZM-9 (described in U.S. Pat. No. 6,713,041, incorporated by reference herein in its entirety) or silico-alumino-phosphates such as SAPO-34 with their acid sites (H⁺ sites) successfully replaced by metal cations, such as Li⁺, K⁺, Ag⁺ and Cu²⁺. The ion-exchanged molecular sieves used in the present invention have preferred elliptical or oblong micropores in cross-section with a largest minor crystallographic free pore diameter of 3.6 Angstroms (Å) or less, capable of separating CO₂ and CH₄ mixtures based on the molecular sizes (kinetic diameters) of CO₂ (3.3 Å) and CH₄ (3.8 Å). Thus, addition of a small weight percent of the ion-exchanged molecular sieves to a continuous polymer matrix increases CO₂/CH₄ selectivity and CO₂ permeability (or CO₂ permeance) for CO₂/CH₄ separation.

In some cases a post-treatment step can be added after the membrane has been made to improve selectivity that does not otherwise change or damage the membrane, or cause the membrane to lose performance with time. The post-treatment step can involve coating the top surface of the mixed matrix membrane with a thin layer of material such as a polysiloxane, a fluoro-polymer, a thermally curable silicone rubber, or a UV radiation curable epoxy silicone.

The current invention is suitable for large scale membrane production and can be integrated into commercial polymer membrane manufacturing processes.

The invention provides a process for separating at least one gas or liquid from a mixture of gases or liquids. The process comprises providing a mixed matrix membrane comprising ion-exchanged molecular sieve particles uniformly dispersed in a continuous polymer matrix which is permeable to said at least one gas or one liquid; contacting the mixture on one side of the mixed matrix membrane to cause said at least one gas or liquid to permeate the mixed matrix membrane; and removing from the opposite side of the membrane a permeate gas or liquid composition comprising a portion of said at least one gas or liquid which permeated said membrane.

The mixed matrix membranes of the present invention are suitable for a variety of liquid, gas, and vapor separations such as desalination of water by reverse osmosis, deep desulfurization of gasoline and diesel fuels, ethanol/water separations, pervaporation dehydration of aqueous/organic mixtures, CO₂/CH₄, CO₂/N₂, H₂/CH₄, O₂/N², olefin/paraffin, iso/normal paraffins separations, and other light gas mixture separations.

### DETAILED DESCRIPTION OF THE INVENTION

Mixed matrix membranes containing dispersed molecular sieve particles in a continuous polymer matrix retain polymer processability and improved selectivity for separations due to the superior molecular sieving and sorption properties of the molecular sieve materials. MMMs have received worldwide attention during the last two decades.

US 2005/0139065 A1 to Miller et al., entitled “Mixed matrix membranes with low silica-to-alumina ratio molecular sieves and methods for making and using the membranes”, reports the incorporation of low silica-to-alumina (Si/Al) ratio molecular sieves into a polymer membrane with a Si/Al molar ratio of the molecular sieves preferably less than 1.0. Miller et al. claim that when the low Si/Al ratio molecular sieves are properly interspersed with a continuous polymer matrix, the MMM ideally will exhibit improved gas separation performance even without functionalizing the surface of the molecular sieves using organosilicon coupling agent. This invention, however, eliminates the use of many high Si/Al ratio zeolites with suitable micropore size and excellent molecular sieving separation property in MMMs. Furthermore, our experimental results showed that some of the low Si/Al ratio, high acidity silicoaluminophosphate (SAPO) molecular sieves (e.g., SAPO-34 with Si/Al ratio of 0.14) reacted with and therefore partially decomposed some polymer matrices (e.g., polyimides and polyamides). The MMMs made from these low Si/Al ratio, high acidity SAPO molecular sieves showed no CO₂/CH₄ selectivity improvement for CO₂/CH₄ gas separation compared to the membranes made from the corresponding polymer matrices.

Ion exchange has been reported previously to change the permeance and selectivity of inorganic zeolite membranes. See Hong, et al., MICROPOR. MESOPOR. MATER., 106:140 (2007); Kusakabe, et al., J. MEMBR. SCI., 148:13 (1998). However, they have not been reported to having been used in mixed matrix membranes prior to the present invention.

The present invention pertains to novel mixed matrix membranes (MMMs) comprising ion-exchanged molecular sieves such as UZM-5 zeolite ion-exchanged with Li⁺ cation (Li-UZM-5) and a continuous polymer matrix. These MMMs comprising ion-exchanged molecular sieves, in the form of symmetric dense film, asymmetric flat sheet, asymmetric hollow, or thin-film composite, have exhibited simultaneously increased selectivity and permeability (or permeance) over the polymer-only membranes and the mixed matrix membranes made from unexchanged molecular sieves for gas separations. The term “mixed matrix” as used in this invention means that the membrane has a selective permeable layer which comprises a continuous polymer matrix and discrete ion-exchanged molecular sieve particles uniformly dispersed throughout the continuous polymer matrix.

The present invention provides a novel method of making mixed matrix membranes comprising ion-exchanged molecular sieves. The method comprises: (a) dispersing the ion-exchanged molecular sieve particles in a mixture of two or more organic solvents by ultrasonic mixing and/or mechanical stirring or other method to form a molecular sieve slurry; (b) dissolving a suitable polymer in the molecular sieve slurry to functionalize the surface of the ion-exchanged molecular sieve particles; (c) dissolving a polymer that serves as a continuous polymer matrix in the polymer functionalized ion-exchanged molecular sieve slurry to form a stable ion-exchanged molecular sieve/polymer suspension; (d) fabricating a mixed matrix membrane in a form of symmetric dense film, asymmetric flat sheet, asymmetric hollow fiber, or thin film composite using the stable ion-exchanged molecular sieve/polymer suspension. The mixed matrix membrane prepared by the present invention comprises uniformly dispersed polymer-functionalized ion-exchanged molecular sieve particles throughout the continuous polymer matrix.

In some cases a membrane post-treatment step can be added to improve selectivity but does not change or damage the membrane, or cause the membrane to lose performance with time. The membrane post-treatment step can involve coating the top surface of the mixed matrix membrane with a thin layer of material such as a polysiloxane, a fluoro-polymer, a thermally curable silicone rubber, or a UV radiation curable epoxy silicone.

Molecular sieve materials are microporous crystals with pores of a well-defined size ranging from about 0.2 to 2 nm. This discrete porosity provides molecular sieving properties to these materials which have found wide applications as catalysts and sorption media. Molecular sieves have framework structures which may be characterized by distinctive wide-angle X-ray diffraction patterns. Molecular sieve structure types can be identified by their structure type code as assigned by the IZA Structure Commission following the rules set up by the IUPAC Commission on Zeolite Nomenclature. Zeolites are a subclass of molecular sieves based on an aluminosilicate composition. Non-zeolitic molecular sieves are based on other compositions such as aluminophosphates, silico-aluminophosphates, and silica. Molecular sieves of different chemical compositions can have the same framework structure. Microporous molecular sieve materials may be characterized as being “large pore”, “medium pore” or “small pore” molecular sieves. As used in the present invention, the term “large pore” refers to molecular sieves which have greater than or equal to 12-ring openings in their framework structure, the term “medium pore” refers to molecular sieves which have 10-ring openings in their framework structure, and the term “small pore” refers to molecular sieves which have less than or equal to 8-ring openings in their framework structure. In addition, as used in the present invention, the term “1-dimensional” or “1-dimensional pores” refers to the fact that the pores in the molecular sieves are essentially parallel and do not intersect. The terms “2-dimensional”, “3-dimensional”, “2-dimensional pores”, and “3-dimensional pores” refer to pores which intersect with each other. The molecular sieves of the present invention may be 1-dimensional, 2-dimensional, or 3-dimensional.

A pore system of a molecular sieve is generally characterized by a major and a minor dimension. For example, molecular sieves having the IUPAC structure of DDR has a major diameter of 4.4 Angstroms (Å) and a minor diameter of 3.6 Å. In some cases, molecular sieves can have 1, 2, or even 3 different pore systems. For the ion-exchanged molecular sieves used in the present invention, the pore system with the largest minor free crystallographic diameter will effectively control the diffusion rate through the molecular sieves.

The ion-exchanged molecular sieves of this invention are capable of separating mixtures of molecular species based on the molecular size or kinetic diameter (molecular sieving mechanism). The separation is accomplished by the smaller molecular species entering the intracrystalline void space while excluding larger species. The kinetic diameters of various molecules such as oxygen (O₂), nitrogen (N₂), carbon dioxide (CO₂), carbon monoxide (CO) and various hydrocarbons are provided in Breck, ZEOLITE MOLECULAR SIEVES, John Wiley and Sons, 1974, p. 636.

The ion-exchanged molecular sieves of this invention improve the performance of the MMM by including selective holes/pores with a size that permits a smaller gas molecule such as carbon dioxide to pass through, but either does not permit another larger gas molecule such as methane to pass through, or permits it to pass through at a significantly slower rate. The ion-exchanged molecular sieves should have higher selectivity for the desired separations than the original un-exchanged molecular sieve in acid form (H⁺ form) and the polymer matrix to enhance the performance of the MMM. The molecular sieve materials in the MMMs provided in this invention are crystalline microporous aluminosilicates such as UZM-25, UZM-5 and UZM-9 or silico-alumino-phosphates such as SAPO-34 with their acid sites (H⁺ sites) successfully replaced by metal cations, such as Li⁺, Na⁺, K⁺, Cs⁺, Sr²⁺, Zn²⁺, Ag⁺ and Cu²⁺. The ion-exchanged molecular sieves used in the present invention have preferred elliptical or oblong micropores in cross-section with a largest minor crystallographic free pore diameter of 3.6 Angstroms (Å) or less, capable of separating CO₂ and CH₄ mixtures based on the molecular sizes (kinetic diameters) of CO₂ (3.3 Å) and CH₄ (3.8 Å). Thus, addition of a small weight percent of the ion-exchanged molecular sieves to a continuous polymer matrix increases CO₂/CH₄ selectivity and CO₂ permeability (or CO₂ permeance) for CO₂/CH₄ separation.

Methods used to make ion-exchanged molecular sieves described in the current invention are well known in the art. See Hong, et al., MICROPOR. MESOPOR. MATER., 106:140 (2007); Kusakabe, et al., J. MEMBR. SCI., 148:13 (1998). After ion exchange, the molecular sieves are usually dried before incorporating into a continuous polymer matrix to make MMMs.

Preferred molecular sieves used for ion exchange treatment in the present invention include molecular sieves having IZA structural designations of AEI, AFX, CHA, CDO, DDR, ERI, LEV, LTA, NSI, GIS and UFI. Some representative preferred molecular sieves used in the present invention include, but are not limited to, UZM-5, DDR, SSZ-62, SSZ-13, ERS-12, CDS-1, MCM-65, MCM-47, UZM-12, 4A, 5A, UZM-9, UZM-25, SAPO-44, SAPO-47, SAPO-17, CVX-7, SAPO-35, SAPO-56, SAPO-43, and mixtures thereof. The most preferred molecular sieves used in the present invention include UZM-5 (3.6×4.4 Å), DDR (3.6×4.4 Å), UZM-25 (2.5×4.2 Å, 3.1×4.7 Å), CDS-1 (2.5×4.2 Å, 3.1×4.7 Å), MCM-65 (2.5×4.2 Å, 3.1×4.7 Å), SAPO-56, Nu-6(2) (2.5×4.5 Å, 2.4×4.8 Å), and mixtures thereof. The preferred metal cations used for ion exchange treatment of these molecular sieves include, but are not limited to, Li⁺, Na⁺, K⁺, Cs⁺, Sr²⁺, Zn²⁺, Ag⁺ and Cu²⁺.

The particle size of the ion-exchanged molecular sieve particles dispersed in the continuous polymer matrix of the MMMs in the present invention should be small enough to form a uniform dispersion of the particles in the continuous polymer matrix. The median particle size should be less than about 10 μm, preferably less than 5 μm, and more preferably less than 1 μm.

The ion-exchanged molecular sieve particles dispersed in the concentrated suspension are functionalized by a suitable polymer which has good compatibility (or miscibility) with the continuous polymer matrix (e.g., polyethersulfone (PES) can be used to functionalize the outside surface of the ion-exchanged molecular sieve particles when Matrimid polyimide is used as the continuous polymer matrix in the MMM), which results in the formation of either polymer-O—Si covalent bonds via reactions between the hydroxyl (—OH) groups on the surfaces of the ion-exchanged molecular sieve particles and the functional groups (e.g., hydroxyl (—OH) groups) at the polymer chain ends or at the polymer side chains or hydrogen bonds between the hydroxyl groups on the surfaces of the ion-exchanged molecular sieve particles and the functional groups such as ether groups on the polymer chains.

Preferably, the polymers used to functionalize the outside surface of the ion-exchanged molecular sieve particles in the present invention contain functional groups such as hydroxyl or amino groups that can form hydrogen bonding with the hydroxyl groups on the surfaces of the outside surface of the ion-exchanged molecular sieve particles. More preferably, the polymers used to functionalize the outside surface of the ion-exchanged molecular sieve particles contain functional groups such as hydroxyl or isocyanate groups that can react with the hydroxyl groups on the outside surface of the ion-exchanged molecular sieve particles to form polymer-O-molecular sieve covalent bonds. Thus, good adhesion between the ion-exchanged molecular sieves and polymer is achieved. Representatives of such polymers are hydroxyl or amino group-terminated or ether polymers such as polyethersulfones (PESs), sulfonated PESs, cellulose triacetate, cellulose acetate, poly(vinyl esters) such as poly(vinyl acetate) and poly(vinyl propionate), poly(vinyl ethers), polyethers such as hydroxyl group-terminated poly(ethylene oxide)s, amino group-terminated poly(ethylene oxide)s, or isocyanate group-terminated poly(ethylene oxide)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), polyether ketones, poly(ethylene imine)s, poly(amidoamine)s, poly(vinyl alcohol)s, poly(allyl amine)s, poly(vinyl amine)s, and polyetherimides such as Ultem (or Ultem 1000) sold under the trademark Ultem®, manufactured by GE Plastics, as well as hydroxyl group-containing glassy polymers such as cellulosic polymers including cellulose acetate, cellulose triacetate, cellulose acetate-butyrate, cellulose propionate, ethyl cellulose, methyl cellulose, and nitrocellulose.

The weight ratio of the ion-exchanged molecular sieves to the polymer used to functionalize the ion-exchanged molecular sieves in the MMMs of the current invention can be within a broad range, but not limited to, from about 1:20 to 100:1 based on the polymer used to functionalize the ion-exchanged molecular sieves, i.e. 5 weight parts of ion-exchanged molecular sieve per 100 weight parts of polymer used to functionalize the ion-exchanged molecular sieves to about 100 weight parts of ion-exchanged molecular sieve per 1 weight part of polymer used to functionalize the ion-exchanged molecular sieves depending upon the properties sought as well as the dispersibility of a particular ion-exchanged molecular sieves in a particular suspension. Preferably the weight ratio of the ion-exchanged molecular sieves to the polymer used to functionalize the ion-exchanged molecular sieves in the MMMs of the current invention is in the range from about 10:1 to 1:2.

The stabilized suspension contains ion-exchanged molecular sieve particles uniformly dispersed in the continuous polymer matrix. The MMM prepared by the present invention comprises uniformly dispersed ion-exchanged molecular sieve particles throughout the continuous polymer matrix. The polymer that serves as the continuous polymer matrix in the MMM of the present invention provides a wide range of properties important for separations, and modifying it can improve membrane selectivity. A material with a high glass transition temperature (Tg), high melting point, and high crystallinity is preferred for most gas separations. Glassy polymers (i.e., polymers below their Tg) have stiffer polymer backbones and therefore let smaller molecules such as hydrogen and helium permeate the membrane more quickly and larger molecules such as hydrocarbons permeate the membrane more slowly. Preferably, the polymer that serves as the continuous polymer matrix in the MMM of the present invention is rigid, glassy polymers. The weight ratio of the ion-exchanged molecular sieves to the polymer that serves as the continuous polymer matrix in the MMM of the current invention can be within a broad range from about 1:100 (1 weight part of ion-exchanged molecular sieves per 100 weight parts of the polymer that serves as the continuous polymer matrix) to about 1:1 (100 weight parts of ion-exchanged molecular sieves per 100 weight parts of the polymer that serves as the continuous polymer matrix) depending upon the properties sought as well as the dispersibility of the particular ion-exchanged molecular sieves in the particular continuous polymer matrix. Preferably the weight ratio of the ion-exchanged molecular sieves to the polymer that serves as the continuous polymer matrix in the MMMs of the current invention is in the range from about 1:10 to 1:1.

Typical polymers that serve as the continuous polymer matrix in the MMM can be selected from, but is not limited to, polysulfones; sulfonated polysulfones; polyethersulfones (PESs); sulfonated PESs; polyethers; polyetherimides such as Ultem (or Ultem 1000) sold under the trademark Ultem®, manufactured by GE Plastics, poly(styrene)s, including styrene-containing copolymers such as acrylonitrilestyrene copolymers, styrene-butadiene copolymers and styrene-vinylbenzylhalide copolymers; polycarbonates; cellulosic polymers, such as cellulose acetate, cellulose triacetate, cellulose acetate-butyrate, cellulose propionate, ethyl cellulose, methyl cellulose, nitrocellulose; polyamides; polyimides such as Matrimid sold under the trademark Matrimid® by Huntsman Advanced Materials (Matrimid® 5218 refers to a particular polyimide polymer sold under the trademark Matrimid®) and P84 or P84HT sold under the tradename P84 and P84HT respectively from HP Polymers GmbH; polyamide/imides; polyketones, polyether ketones; poly(arylene oxide)s such as poly(phenylene oxide) and poly(xylene oxide); poly(esteramide-diisocyanate); polyurethanes; polyesters (including polyarylates), such as poly(ethylene terephthalate), poly(alkyl methacrylate)s, poly(acrylate)s, poly(phenylene terephthalate); polysulfides; polymers from monomers having alpha-olefinic unsaturation other than mentioned above such as poly(ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol), poly(vinyl ester)s such as poly(vinyl acetate) and poly(vinyl propionate), poly(vinyl pyridine)s, poly(vinyl pyrrolidone)s, poly(vinyl ether)s, poly(vinyl ketone)s, poly(vinyl aldehyde)s such as poly(vinyl formal) and poly(vinyl butyral), poly(vinyl amide)s, poly(vinyl amine)s, poly(vinyl urethane)s, poly(vinyl urea)s, poly(vinyl phosphate)s, and poly(vinyl sulfate)s; polyallyls; poly(benzobenzimidazole)s; polyhydrazides; polyoxadiazoles; polytriazoles; poly(benzimidazole); polybenzoxazoles; polycarbodiimides; polyphosphazines; microporous polymers; and interpolymers, including block interpolymers containing repeating units from the above such as terpolymers of acrylonitrile-vinyl bromide-sodium salt of para-sulfophenylmethallyl ethers; and grafts and blends containing any of the foregoing. Typical substituents providing substituted polymers include halogens such as fluorine, chlorine and bromine; hydroxyl groups; lower alkyl groups; lower alkoxy groups; monocyclic aryl; lower acryl groups and the like.

Some preferred polymers that can serve as the continuous polymer matrix include, but are not limited to, polysulfones, sulfonated polysulfones, polyethersulfones (PESs), sulfonated PESs, polyethers, polyetherimides such as Ultem (or Ultem 1000) sold under the trademark Ultem®, manufactured by GE Plastics, and available from GE polymerland, cellulosic polymers such as cellulose acetate and cellulose triacetate, polyamides, polyimides such as Matrimid sold under the trademark Matrimid® by Huntsman Advanced Materials (Matrimid® 5218 refers to a particular polyimide polymer sold under the trademark Matrimid®), P84 or P84HT sold under the tradename P84 and P84HT respectively from HP Polymers GmbH, poly(3,3′,4,4′-benzophenone tetracarboxylic dianhydride-pyromellitic dianhydride-3,3′,5,5′-tetramethyl-4,4′-methylene dianiline) (poly(BTDA-PMDA-TMMDA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-benzophenone tetracarboxylic dianhydride-3,3′,5,5′-tetramethyl-4,4′-methylene dianiline) (poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), poly[2,2′-bis-(3,4-dicarboxyphenyl)hexafluoropropane dianhydride-1,3-phenylenediamine] (poly(6FDA-m-PDA)), poly[2,2′-bis-(3,4-dicarboxyphenyl)hexafluoropropane dianhydride-1,3-phenylenediamine-3,5-diaminobenzoic acid)] (poly(6FDA-m-PDA-DABA)), poly[2,2′-bis-(3,4-dicarboxyphenyl)hexafluoropropane dianhydride-2,2-bis(3-amino-4-hydroxyphenyl)-hexafluoropropane] (poly(6FDA-bis-AP-AF)), polyamide/imides, polybenzoxazoles, polyketones, polyether ketones, and microporous polymers.

The most preferred polymers that can serve as the continuous polymer matrix include, but are not limited to, polyimides such as Matrimid®, P84®, poly(BTDA-PMDA-TMMDA), poly(BTDA-PMDA-ODPA-TMMDA), poly(DSDA-TMMDA), poly(BTDA-TMMDA), poly(DSDA-PMDA-TMMDA), or poly(6FDA-bis-AP-AF), polyetherimides such as Ultem®, polyethersulfones, polysulfones, cellulose acetate, cellulose triacetate, poly(vinyl alcohol)s, and microporous polymers.

Microporous polymers (or as so-called “polymers of intrinsic microporosity”) described herein are polymeric materials that possess microporosity that is intrinsic to their molecular structures. See McKeown, et al., CHEM. COMMUN., 2780 (2002); Budd, et al., ADV. MATER., 16:456 (2004); McKeown, et al., CHEM. EUR. J., 11:2610 (2005). This type of microporous polymers can be used as the continuous polymer matrix in MMMs in the current invention. The microporous polymers have a rigid rod-like, randomly contorted structure to generate intrinsic microporosity. These microporous polymers exhibit behavior analogous to that of conventional microporous molecular sieve materials, such as large and accessible surface areas, interconnected intrinsic micropores of less than 2 nm in size, as well as high chemical and thermal stability, but, in addition, possess properties of conventional polymers such as good solubility and easy processability. Moreover, these microporous polymers possess polyether polymer chains that have favorable interaction between carbon dioxide and the ethers.

The solvents used for dispersing the ion-exchanged molecular sieve particles in the concentrated suspension and for dissolving the polymer used to functionalize the ion-exchanged molecular sieves and the polymer that serves as the continuous polymer matrix are chosen primarily for their ability to completely dissolve the polymers and for ease of solvent removal in the membrane formation steps. Other considerations in the selection of solvents include low toxicity, low corrosive activity, low environmental hazard potential, availability and cost. Representative solvents for use in this invention include most amide solvents that are typically used for the formation of polymeric membranes, such as N-methylpyrrolidone (NMP) and N,N-dimethyl acetamide (DMAC), methylene chloride, tetrahydrofuran (THF), acetone, N,N-dimethylformamide (DMF), dimethyl sulfoxide (DMSO), toluene, dioxanes, 1,3-dioxolane, mixtures thereof, others known to those skilled in the art and mixtures thereof.

In the present invention, MMMs can be fabricated with various membrane structures such as mixed matrix dense films, asymmetric flat sheet MMMs, asymmetric thin film composite MMMs, or asymmetric hollow fiber MMMs from the stabilized concentrated MMM suspensions comprising a mixture of solvents, ion-exchanged molecular sieves, polymer used to functionalize the ion-exchanged molecular sieves, and a continuous polymer matrix. One method to form an asymmetric MMM comprises casting or spinning an asymmetric MMM layer using the stabilized concentrated MMM suspension, and then drying the asymmetric MMM layer through a direct air drying method (see U.S. Pat. No. 4,855,048) or through a solvent exchange method (see U.S. Pat. No. 3,133,132) to form a dry asymmetric MMM. As another example, the stabilized concentrated MMM suspension can be sprayed, spin coated, poured into a sealed glass ring on top of a clean glass plate, or cast with a doctor knife. In another method, a porous substrate can be dip coated with the stabilized concentrated MMM suspension. One solvent removal technique used in the present invention is the evaporation of volatile solvents by ventilating the atmosphere above the forming membrane with a diluent dry gas and drawing a vacuum. Another solvent removal technique used in the present invention calls for immersing the cast thin layer of the concentrated suspension (previously cast on a glass plate or on a porous or permeable substrate) in a non-solvent for the polymers that is miscible with the solvents of the suspension. To facilitate the removal of the solvents, the substrate and/or the atmosphere or non-solvent into which the thin layer of dispersion is immersed can be heated. When the MMM is substantially free of solvents, it can be detached from the glass plate to form a free-standing (or self-supporting) structure or the MMM can be left in contact with a porous or permeable support substrate to form an integral composite assembly. Additional fabrication steps that can be used include washing the MMM in a bath of an appropriate liquid to extract residual solvents and other foreign matters from the membrane, air drying the washed MMM to remove residual liquid, and in some cases coating a thin layer of material such as a polysiloxane, a fluoro-polymer, a thermally curable silicone rubber, or a UV radiation curable epoxy silicone to fill the surface minor defects on the MMM. One preferred embodiment of the current invention is in the form of an asymmetric flat sheet MMM for gas separation comprising a smooth thin dense selective layer on top of a highly porous supporting layer.

The method of the present invention for producing high performance MMMs is suitable for large scale membrane production and can be integrated into commercial polymer membrane manufacturing process. The MMMs comprising ion-exchanged molecular sieves fabricated by the method described in the current invention exhibit significantly enhanced selectivity and permeability over the polymer-only membranes and the MMMs made from unexchanged molecular sieves.

The invention provides a process for separating at least one gas or liquid from a mixture of gases or liquids using the mixed matrix membrane described in the present invention, the process comprising: (a) providing a mixed matrix membrane comprising ion-exchanged molecular sieve particles uniformly dispersed in a continuous polymer matrix which is permeable to said at least one gas or one liquid; (b) contacting the mixture on one side of the mixed matrix membrane to cause said at least one gas or liquid to permeate the mixed matrix membrane; and (c) removing from the opposite side of the membrane a permeate gas or liquid composition comprising a portion of said at least one gas or liquid which permeated said membrane.

The MMMs comprising ion-exchanged molecular sieves of the present invention are suitable for a variety of liquid, gas, and vapor separations such as desalination of water by reverse osmosis, deep desulfurization of gasoline and diesel fuels, ethanol/water separations, pervaporation dehydration of aqueous/organic mixtures, CO₂/CH₄, CO₂/N₂, H₂/CH₄, O₂/N₂, olefin/paraffin, iso/normal paraffins separations, and other light gas mixture separations.

The MMMs of the present invention are especially useful in the purification, separation or adsorption of a particular species in the liquid or gas phase. In addition to separation of pairs of gases, these MMMs may, for example, be used for the separation of proteins or other thermally unstable compounds, e.g. in the pharmaceutical and biotechnology industries. The MMMs may also be used in fermenters and bioreactors to transport gases into the reaction vessel and transfer cell culture medium out of the vessel. Additionally, the MMMs may be used for the removal of microorganisms from air or water streams, water purification, ethanol production in a continuous fermentation/membrane pervaporation system, and in detection or removal of trace compounds or metal salts in air or water streams.

The MMMs of the present invention are especially useful in gas separation processes in air purification, petrochemical, refinery, and natural gas industries. Examples of such separations include separation of volatile organic compounds (such as toluene, xylene, and acetone) from an atmospheric gas, such as nitrogen or oxygen and nitrogen recovery from air. Further examples of such separations are for the separation of CO₂ from natural gas, H₂ from N₂, CH₄, and Ar in ammonia purge gas streams, H₂ recovery in refineries, olefin/paraffin separations such as propylene/propane separation, and iso/normal paraffin separations. Any given pair or group of gases that differ in molecular size, for example nitrogen and oxygen, carbon dioxide and methane, hydrogen and methane or carbon monoxide, helium and methane, can be separated using the MMMs described herein. More than two gases can be removed from a third gas. For example, some of the gas components which can be selectively removed from a raw natural gas using the membrane described herein include carbon dioxide, oxygen, nitrogen, water vapor, hydrogen sulfide, helium, and other trace gases. Some of the gas components that can be selectively retained include hydrocarbon gases.

The MMMs described in the current invention are also especially useful in gas/vapor separation processes in chemical, petrochemical, pharmaceutical and allied industries for removing organic vapors from gas streams, e.g. in off-gas treatment for recovery of volatile organic compounds to meet clean air regulations, or within process streams in production plants so that valuable compounds (e.g., vinylchloride monomer, propylene) may be recovered. Further examples of gas/vapor separation processes in which these MMMs may be used are hydrocarbon vapor separation from hydrogen in oil and gas refineries, for hydrocarbon dew pointing of natural gas (i.e. to decrease the hydrocarbon dew point to below the lowest possible export pipeline temperature so that liquid hydrocarbons do not separate in the pipeline), for control of methane number in fuel gas for gas engines and gas turbines, and for gasoline recovery. The MMMs may incorporate a species that adsorbs strongly to certain gases (e.g. cobalt porphyrins or phthalocyanines for O₂ or silver(I) for ethane) to facilitate their transport across the membrane.

These MMMs may also be used in the separation of liquid mixtures by pervaporation, such as in the removal of organic compounds (e.g., alcohols, phenols, chlorinated hydrocarbons, pyridines, ketones) from water such as aqueous effluents or process fluids. A membrane which is ethanol-selective would be used to increase the ethanol concentration in relatively dilute ethanol solutions (5-10% ethanol) obtained by fermentation processes. Another liquid phase separation example using these MMMs is the deep desulfurization of gasoline and diesel fuels by a pervaporation membrane process similar to the process described in U.S. Pat. No. 7,048,846, incorporated by reference herein in its entirety. The MMMs that are selective to sulfur-containing molecules would be used to selectively remove sulfur-containing molecules from fluid catalytic cracking (FCC) and other naphtha hydrocarbon streams. Further liquid phase examples include the separation of one organic component from another organic component, e.g. to separate isomers of organic compounds. Mixtures of organic compounds which may be separated using an inventive membrane include: ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propoanol, isopropylether-isopropanol, methanol-ethanol-isopropanol, and ethylacetate-ethanol-acetic acid.

The MMMs may be used for separation of organic molecules from water (e.g. ethanol and/or phenol from water by pervaporation) and removal of metal and other organic compounds from water.

### EXAMPLES

The following examples are provided to illustrate one or more preferred embodiments of the invention, but are not limited embodiments thereof. Numerous variations can be made to the following examples that lie within the scope of the invention.

### Example 1

### Preparation of poly(3,3′,4,4′-diphenylsulfone tetracarboxylic dianhydride-3,3′,5,5′-tetramethyl-4,4′-methylene dianiline) (poly(DSDA-TMMDA)) and polyethersulfone (PES) blend polymer membrane (abbreviated as Control 1)

4.0 g of poly(DSDA-TMMDA) polyimide polymer and 4.0 g of PES were dissolved in a solvent mixture of NMP and 1,3-dioxolane by mechanical stirring for 2 hours to form a homogeneous casting dope. The resulting homogeneous casting dope was allowed to degas overnight. A Control 1 polymer membrane was prepared from the bubble free casting dope on a clean glass plate using a doctor knife with a 20-mil gap. The dense film together with the glass plate was then put into a vacuum oven. The solvents were removed by slowly increasing the vacuum and the temperature of the vacuum oven. Finally, the membrane was dried at 200° C. under vacuum for at least 48 hours to completely remove the residual solvents to form Control 1.

### Example 2

### Preparation of 30% UZM-5(Si/Al=13)/Poly(DSDA-TMMDA)-PES Mixed Matrix Membrane

### Abbreviated as MMM 1

A PES functionalized UZM-5(Si/Al=13)/poly(DSDA-TMMDA)-PES mixed matrix membrane (abbreviated as MMM 1) containing 30 wt-% of dispersed UZM-5 zeolite particles in a blend poly(DSDA-TMMDA) polyimide and PES continuous matrix was prepared as follows:

1.8 g of UZM-5(Si/Al=13) zeolites were dispersed in a mixture of 11.6 g of NMP and 17.2 g of 1,3-dioxolane by mechanical stirring and ultrasonication for 1 hour to form a slurry. Then 1.0 g of PES was added to functionalize UZM-5(Si/Al=13) zeolites in the slurry. The slurry was stirred for at least 1 hour to completely dissolve PES polymer and functionalize the surface of UZM-5. After that, 3.0 g of poly(DSDA-TMMDA) polyimide polymer and 2.0 g of PES polymer were added to the slurry and the resulting mixture was stirred for another 2 hours to form a stable casting dope containing 30 wt-% of dispersed PES functionalized UZM-5(Si/Al=13) zeolites (weight ratio of UZM-5(Si/Al=13) zeolites to poly(DSDA-TMMDA) and PES is 30:100; weight ratio of PES to poly(DSDA-TMMDA) is 1:1) in the continuous blend poly(DSDA-TMMDA) and PES polymer matrix. The stable casting dope was allowed to degas overnight.

A MMM 1 mixed matrix membrane was prepared on a clean glass plate from the bubble free stable casting dope using a doctor knife with a 20-mil gap. The film together with the glass plate was then put into a vacuum oven. The solvents were removed by slowly increasing the vacuum and the temperature of the vacuum oven. Finally, the membrane was dried at 200° C. under vacuum for at least 48 hours to completely remove the residual solvents to form MMM 1.

### Example 3

### Preparation of 30% Li-UZM-5(Si/Al=13)/Poly(DSDA-TMMDA)-PES Mixed Matrix Membrane

### Abbreviated as MMM 2

A PES functionalized Li⁺-exchanged UZM-5(Si/Al=13)/poly(DSDA-TMMDA)-PES mixed matrix membrane (abbreviated as MMM 2) containing 30 wt-% of dispersed Li⁺-exchanged UZM-5 (Li-UZM-5) zeolite particles in a blend poly(DSDA-TMMDA) polyimide and PES continuous matrix was prepared using similar procedures as described in Example 2, but the molecular sieve particles used in this example are Li⁺-exchanged UZM-5(Si/Al=13) with 51% of the acid sites (H⁺) exchanged with Li⁺ (Li-UZM-5).

### Example 4

### CO₂/CH₄ Separation Properties of Control 1, MMM 1, and MMM 2 Mixed Matrix Membranes

The permeabilities (P_{CO2} and P_{CH4}) and selectivity (α_{CO2/CH4}) of Control 1 prepared in Example 1, MMM 1 prepared in Example 2, and MMM 2 prepared in Example 3 were measured by pure gas measurements at 50° C. under about 690 kPa (100 psig) pressure. The results for CO₂/CH₄ separation are shown in the following table.

It can be seen from the following table that MMM 1 mixed matrix membrane comprising 30 wt-% of UZM-5 zeolite particles showed 10% improvement in α_{CO2/CH4} and 115% improvement in P_{CO2} for CO₂/CH₄ separation compared to Control 1 polymer membrane. MMM 2 mixed matrix membrane comprising 30 wt-% of Li⁺-exchanged UZM-5 zeolite particles showed much higher improvement in both P_{CO2} and α_{CO2/CH4} compared to MMM 1 membrane. MMM 2 showed 28% improvement in α_{CO2/CH4} and 190% improvement in P_{CO2} for CO₂/CH₄ separation compared to Control 1 polymer membrane.

Pure gas permeation test results of Control 1, MMM 1,
and MMM 2 for CO₂/CH₄ separation^{a}

| | P_{CO2} | ΔP_{CO2} | | |
|---|---|---|---|---|
| Membrane | (Barrer) | (Barrer) | α_{CO2/CH4} | Δα_{CO2/CH4} |
| Control 1 | 10.2 | 0 | 24.4 | 0 |
| MMM 1 | 21.9 | 115% | 26.8 | 10% |
| MMM 2 | 29.6 | 190% | 31.2 | 28% |

^{a}Tested at 50° C. under 690 kPa (100 psig) pure gas pressure.

1. A mixed matrix membrane comprising ion-exchanged molecular sieves in a continuous polymer matrix.

2. The mixed matrix membrane of claim 1 wherein said ion-exchanged molecular sieves have an IZA structure selected from the group consisting of AEI, AFX, CHA, CDO, DDR, ERI, LEV, LTA, NSI, GIS and UFI.

3. The mixed matrix membrane of claim 2 wherein said ion-exchanged molecular sieves are selected from the group consisting of UZM-5, DDR, SSZ-62, SSZ-13, ERS-12, CDS-1, MCM-65, MCM-47, UZM-12, 4A, 5A, UZM-9, UZM-25, SAPO-44, SAPO-47, SAPO-17, CVX-7, SAPO-35, SAPO-56, SAPO-43, and mixtures thereof.

4. The mixed matrix membrane of claim 3 wherein said ion-exchanged molecular sieves are selected from the group consisting of UZM-5 (3.6×4.4 Å), DDR (3.6×4.4 Å), UZM-25 (2.5×4.2 Å, 3.1×4.7 Å), CDS-1 (2.5×4.2 Å, 3.1×4.7 Å), MCM-65 (2.5×4.2 Å, 3.1×4.7 ÅA), SAPO-56, Nu-6(2) (2.5×4.5 Å, 2.4×4.8 Å), and mixtures thereof.

5. The mixed matrix membrane of claim 1 wherein said ion-exchanged molecular sieves have been subjected to an ion exchange treatment with an ion selected from the group consisting of Li⁺, Na⁺, K⁺, Cs⁺, Sr²⁺, Zn²⁺, Ag⁺ and Cu²⁺.

6. The mixed matrix membrane of claim 1 wherein said ion-exchanged molecular sieves have been functionalized with a polymer selected from the group consisting of hydroxyl or amino group-terminated or ether polymers, poly(vinyl esters), polyethers, and hydroxyl group-containing glassy polymers.

7. The mixed matrix membrane of claim 1 wherein said ion-exchanged molecular sieves have been functionalized with a polymer selected from the group consisting of polyethersulfones, sulfonated polyethersulfones, cellulose triacetate, cellulose acetate, poly(vinyl acetate) and poly(vinyl propionate), poly(vinyl ethers), hydroxyl group-terminated poly(ethylene oxide)s, amino group-terminated poly(ethylene oxide)s, isocyanate group-terminated poly(ethylene oxide)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), polyether ketones, poly(ethylene imine)s, poly(amidoamine)s, poly(vinyl alcohol)s, poly(allyl amine)s, poly(vinyl amine)s, polyetherimides, cellulose acetate, cellulose triacetate, cellulose acetate-butyrate, cellulose propionate, ethyl cellulose, methyl cellulose, and nitrocellulose.

8. The mixed matrix membrane of claim 6 wherein said ion-exchanged molecular sieves and said polymer used to functionalize said ion-exchanged molecular sieves are present in a weight ratio of about 1:20 to about 100:1.

9. The mixed matrix membrane of claim 8 wherein said ion-exchanged molecular sieves and said polymer used to functionalize said ion-exchanged molecular sieves are present in a weight ratio is from about 10:1 to about 1:2.

10. The mixed matrix membrane of claim 1 wherein said continuous polymer matrix comprises one or more polymers selected from the group consisting of polysulfones, sulfonated polysulfones, polyethersulfones, sulfonated polyethersulfones, polyethers, polyetherimides, poly(styrene)s, styrene-containing copolymers selected from the group consisting of acrylonitrilestyrene copolymers, styrene-butadiene copolymers and styrene-vinylbenzylhalide copolymers, polycarbonates, cellulosic polymers selected from the group consisting of cellulose acetate, cellulose triacetate, cellulose acetate-butyrate, cellulose propionate, ethyl cellulose, methyl cellulose, and nitrocellulose, polyamides; polyimides, polyamide/imides; polyketones, polyether ketones; poly(arylene oxide)s selected from the group consisting of poly(phenylene oxide) and poly(xylene oxide); poly(esteramide-diisocyanate); polyurethanes; polyesters, polyarylates, poly(ethylene terephthalate), poly(alkyl methacrylate)s, poly(acrylate)s, poly(phenylene terephthalate); polysulfides; polymers from monomers having alpha-olefinic unsaturation selected from the group consisting of poly(ethylene), poly(propylene), poly(butene-1), poly(4-methyl pentene-1), polyvinyls, poly(vinyl chloride), poly(vinyl fluoride), poly(vinylidene chloride), poly(vinylidene fluoride), poly(vinyl alcohol), poly(vinyl esters), poly(vinyl acetate), poly(vinyl propionate), poly(vinyl pyridine)s, poly(vinyl pyrrolidone)s, poly(vinyl ether)s, poly(vinyl ketone)s, poly(vinyl aldehyde)s, poly(vinyl formal) and poly(vinyl butyral), poly(vinyl amide)s, poly(vinyl amine)s, poly(vinyl urethane)s, poly(vinyl urea)s, poly(vinyl phosphate)s, and poly(vinyl sulfate)s; polyallyls; poly(benzobenzimidazole)s; polyhydrazides; polyoxadiazoles; polytriazoles; poly(benzimidazole)s; polybenzoxazoles; polycarbodiimides; polyphosphazines; microporous polymers; and interpolymers, block interpolymers containing repeating units and grafts and blends containing any of the foregoing polymers.

11. The mixed matrix membrane of claim 10 wherein said continuous polymer matrix comprises substituted polymers having substituents selected from the group consisting of halogens, hydroxyl groups; lower alkyl groups; lower alkoxy groups; monocyclic aryl; and lower acryl groups.

12. The mixed matrix membrane of claim 1 wherein said continuous polymer matrix comprises one or more polymers selected from the group consisting of polysulfones, sulfonated polysulfones, polyethersulfones, sulfonated polyethersulfones, polyethers, polyetherimides, cellulosic polymers, polyamides, polyimides, poly(3,3′,4,4′-benzophenone tetracarboxylic dianhydride-pyromellitic dianhydride-3,3′,5,5′-tetramethyl-4,4′-methylene dianiline) (poly(BTDA-PMDA-TMMDA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-benzophenone tetracarboxylic dianhydride-3,3′,5,5′-tetramethyl-4,4′-methylene dianiline) (poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), poly[2,2′-bis-(3,4-dicarboxyphenyl)hexafluoropropane dianhydride-1,3-phenylenediamine] (poly(6FDA-m-PDA)), poly[2,2′-bis-(3,4-dicarboxyphenyl)hexafluoropropane dianhydride-1,3-phenylenediamine-3,5-diaminobenzoic acid)] (poly(6FDA-m-PDA-DABA)), poly[2,2′-bis-(3,4-dicarboxyphenyl)hexafluoropropane dianhydride-2,2-bis(3-amino-4-hydroxyphenyl)-hexafluoropropane] (poly(6FDA-bis-AP-AF)), polyamide/imides, polybenzoxazoles, polyketones, polyether ketones, and microporous polymers.

13. The mixed matrix membrane of claim 1 wherein said continuous polymer matrix comprises at least one polymer selected from the group consisting of polyimides, polyetherimides, polyethersulfones, polysulfones, polybenzoxazoles, cellulose acetate, cellulose triacetate, poly(vinyl alcohol)s, and microporous polymers.

14. A method of making mixed matrix membranes containing ion-exchanged molecular sieves comprising first dispersing ion-exchanged molecular sieve particles having an outer surface in a mixture of two or more organic solvents to form a molecular sieve slurry; then dissolving a polymer in the molecular sieve slurry to functionalize the outer surface of the ion-exchanged molecular sieve particles; dissolving a polymer that serves as a continuous polymer matrix in the polymer functionalized ion-exchanged molecular sieve slurry to form a stable ion-exchanged molecular sieve/polymer suspension; and as a last step, fabricating a mixed matrix membrane in a form of a symmetric dense film, an asymmetric flat sheet, an asymmetric hollow fiber, or a thin film composite using the stable ion-exchanged molecular sieve/polymer suspension.

15. The method of making mixed matrix membranes of claim 14 wherein said ion-exchanged molecular sieves have an IZA structure selected from the group consisting of AEI, AFX, CHA, CDO, DDR, ERI, LEV, LTA, NSI, GIS and UFI.

16. The method of making mixed matrix membranes of claim 14 wherein said ion-exchanged molecular sieves are selected from the group consisting of UZM-5, DDR, SSZ-62, SSZ-13, ERS-12, CDS-1, MCM-65, MCM-47, UZM-12, 4A, 5A, UZM-9, UZM-25, SAPO-44, SAPO-47, SAPO-17, CVX-7, SAPO-35, SAPO-56, SAPO-43, and mixtures thereof.

17. The method of making mixed matrix membranes of claim 14 wherein said ion-exchanged molecular sieves are selected from the group consisting of UZM-5 (3.6×4.4 Å), DDR (3.6×4.4 Å), UZM-25 (2.5×4.2 Å, 3.1×4.7 Å), CDS-1 (2.5×4.2 Å, 3.1×4.7 Å), MCM-65 (2.5×4.2 Å, 3.1×4.7 Å), SAPO-56, Nu-6(2) (2.5×4.5 Å, 2.4×4.8 Å), and mixtures thereof.

18. The method of making mixed matrix membranes of claim 14 wherein said ion-exchanged molecular sieves have been subjected to an ion exchange treatment with an ion selected from the group consisting of Li⁺, Na⁺, K⁺, Cs⁺, Sr²⁺, Zn²⁺, Ag⁺ and Cu²⁺.

19. The method of making mixed matrix membranes of claim 14 wherein said ion-exchanged molecular sieves have been functionalized with a polymer selected from the group consisting of hydroxyl or amino group-terminated or ether polymers, poly(vinyl esters), polyethers, and hydroxyl group-containing glassy polymers.

20. The method of making mixed matrix membranes of claim 14 wherein said ion-exchanged molecular sieves have been functionalized with a polymer selected from the group consisting of polyethersulfones, sulfonated polyethersulfones, cellulose triacetate, cellulose acetate, poly(vinyl acetate) and poly(vinyl propionate), poly(vinyl ethers), hydroxyl group-terminated poly(ethylene oxide)s, amino group-terminated poly(ethylene oxide)s, isocyanate group-terminated poly(ethylene oxide)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), polyether ketones, poly(ethylene imine)s, poly(amidoamine)s, poly(vinyl alcohol)s, poly(allyl amine)s, poly(vinyl amine)s, polyetherimides, cellulose acetate, cellulose triacetate, cellulose acetate-butyrate, cellulose propionate, ethyl cellulose, methyl cellulose, and nitrocellulose.

21. The method of making mixed matrix membranes of claim 20 wherein said ion-exchanged molecular sieves and said polymer used to functionalize said ion-exchanged molecular sieves are present in a weight ratio of about 1:20 to about 100:1.

22. The method of making mixed matrix membranes of claim 20 wherein said ion-exchanged molecular sieves and said polymer used to functionalize said ion-exchanged molecular sieves are present in a weight ratio is from about 10:1 to about 1:2.

23. The method of making mixed matrix membranes of claim 14 wherein said continuous polymer matrix comprises one or more polymers selected from the group consisting of polysulfones, sulfonated polysulfones, polyethersulfones, sulfonated polyethersulfones, polyethers, polyetherimides, poly(styrene)s, styrene-containing copolymers selected from the group consisting of acrylonitrilestyrene copolymers, styrene-butadiene copolymers and styrene-vinylbenzylhalide copolymers, polycarbonates, cellulosic polymers selected from the group consisting of cellulose acetate, cellulose triacetate, cellulose acetate-butyrate, cellulose propionate, ethyl cellulose, methyl cellulose, and nitrocellulose, polyamides; polyimides, polyamide/imides; polyketones, polyether ketones; poly(arylene oxide)s selected from the group consisting of poly(phenylene oxide) and poly(xylene oxide); poly(esteramide-diisocyanate); polyurethanes; polyesters, polyarylates, poly(ethylene terephthalate), poly(alkyl methacrylate)s, poly(acrylate)s, poly(phenylene terephthalate); polysulfides; polymers from monomers having alpha-olefinic unsaturation selected from the group consisting of poly(ethylene), poly(propylene), poly(butene-1), poly(4-methyl pentene-1), polyvinyls, poly(vinyl chloride), poly(vinyl fluoride), poly(vinylidene chloride), poly(vinylidene fluoride), poly(vinyl alcohol), poly(vinyl esters), poly(vinyl acetate), poly(vinyl propionate), poly(vinyl pyridine)s, poly(vinyl pyrrolidone)s, poly(vinyl ether)s, poly(vinyl ketone)s, poly(vinyl aldehyde)s, poly(vinyl formal) and poly(vinyl butyral), poly(vinyl amide)s, poly(vinyl amine)s, poly(vinyl urethane)s, poly(vinyl urea)s, poly(vinyl phosphate)s, and poly(vinyl sulfate)s; polyallyls; poly(benzobenzimidazole)s; polyhydrazides; polyoxadiazoles; polytriazoles; poly(benzimidazole)s; polybenzoxazoles; polycarbodiimides; polyphosphazines; microporous polymers; and interpolymers, block interpolymers containing repeating units and grafts and blends containing any of the foregoing polymers.

24. The method of making mixed matrix membranes of claim 14 wherein said continuous polymer matrix comprises substituted polymers having substituents selected from the group consisting of halogens, hydroxyl groups; lower alkyl groups; lower alkoxy groups; monocyclic aryl; and lower acryl groups.

25. The method of making mixed matrix membranes of claim 14 wherein said continuous polymer matrix comprises one or more polymers selected from the group consisting of polysulfones, sulfonated polysulfones, polyethersulfones, sulfonated polyethersulfones, polyethers, polyetherimides, cellulosic polymers, polyamides, polyimides, poly(3,3′,4,4′-benzophenone tetracarboxylic dianhydride-pyromellitic dianhydride-3,3′,5,5′-tetramethyl-4,4′-methylene dianiline) (poly(BTDA-PMDA-TMMDA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-benzophenone tetracarboxylic dianhydride-3,3′,5,5′-tetramethyl-4,4′-methylene dianiline) (poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), poly[2,2′-bis-(3,4-dicarboxyphenyl)hexafluoropropane dianhydride-1,3-phenylenediamine] (poly(6FDA-m-PDA)), poly[2,2′-bis-(3,4-dicarboxyphenyl)hexafluoropropane dianhydride-1,3-phenylenediamine-3,5-diaminobenzoic acid)] (poly(6FDA-m-PDA-DABA)), poly[2,2′-bis-(3,4-dicarboxyphenyl)hexafluoropropane dianhydride-2,2-bis(3-amino-4-hydroxyphenyl)-hexafluoropropane] (poly(6FDA-bis-AP-AF)), polyamide/imides, polybenzoxazoles, polyketones, polyether ketones, and microporous polymers.

26. The method of making mixed matrix membranes of claim 14 wherein said continuous polymer matrix comprises at least one polymer selected from the group consisting of polyimides, polyetherimides, polyethersulfones, polysulfones, polybenzoxazoles, cellulose acetate, cellulose triacetate, poly(vinyl alcohol)s, and microporous polymers.

27. A process for separating at least one gas or liquid from a mixture of gases or liquids said process comprising providing a mixed matrix membrane comprising ion-exchanged molecular sieve particles uniformly dispersed in a continuous polymer matrix wherein said mixed matrix membrane is permeable to said at least one gas or one liquid; contacting the mixture of gases or liquids on one side of the mixed matrix membrane to cause said at least one gas or liquid to permeate the mixed matrix membrane; and removing from an opposite side of the mixed matrix membrane a permeate gas or liquid composition comprising a portion of said at least one gas or liquid that permeated said membrane.

28. The process of claim 27 wherein said ion-exchanged molecular sieves have an IZA structure selected from the group consisting of AEI, AFX, CHA, CDO, DDR, ERI, LEV, LTA, NSI, GIS and UFI.

29. The process of claim 27 wherein said ion-exchanged molecular sieves are selected from the group consisting of UZM-5, DDR, SSZ-62, SSZ-13, ERS-12, CDS-1, MCM-65, MCM-47, UZM-12, 4A, 5A, UZM-9, UZM-25, SAPO-44, SAPO-47, SAPO-17, CVX-7, SAPO-35, SAPO-56, SAPO-43, and mixtures thereof.

30. The process of claim 27 wherein said ion-exchanged molecular sieves are selected from the group consisting of UZM-5 (3.6×4.4 Å), DDR (3.6×4.4 Å), UZM-25 (2.5×4.2 Å, 3.1×4.7 Å), CDS-1 (2.5×4.2 Å, 3.1×4.7 Å), MCM-65 (2.5×4.2 Å, 3.1×4.7 Å), SAPO-56, Nu-6(2) (2.5×4.5 Å, 2.4×4.8 Å), and mixtures thereof.

31. The process of claim 27 wherein said ion-exchanged molecular sieves have been subjected to an ion exchange treatment with an ion selected from the group consisting of Li⁺, Na⁺, K⁺, Cs⁺, Sr²⁺, Zn²⁺, Ag⁺ and Cu²⁺.

32. The process of claim 27 wherein said ion-exchanged molecular sieves have been functionalized with a polymer selected from the group consisting of hydroxyl or amino group-terminated or ether polymers, poly(vinyl esters), polyethers, and hydroxyl group-containing glassy polymers.

33. The process of claim 27 wherein said ion-exchanged molecular sieves have been functionalized with a polymer selected from the group consisting of polyethersulfones, sulfonated polyethersulfones, cellulose triacetate, cellulose acetate, poly(vinyl acetate) and poly(vinyl propionate), poly(vinyl ethers), hydroxyl group-terminated poly(ethylene oxide)s, amino group-terminated poly(ethylene oxide)s, isocyanate group-terminated poly(ethylene oxide)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), polyether ketones, poly(ethylene imine)s, poly(amidoamine)s, poly(vinyl alcohol)s, poly(allyl amine)s, poly(vinyl amine)s, polyetherimides, cellulose acetate, cellulose triacetate, cellulose acetate-butyrate, cellulose propionate, ethyl cellulose, methyl cellulose, and nitrocellulose.

34. The process of claim 32 wherein said ion-exchanged molecular sieves and said polymer used to functionalize said ion-exchanged molecular sieves are present in a weight ratio of about 1:20 to about 100:1.

35. The process of claim 32 wherein said ion-exchanged molecular sieves and said polymer used to functionalize said ion-exchanged molecular sieves are present in a weight ratio is from about 10:1 to about 1:2.

36. The process of claim 27 wherein said continuous polymer matrix comprises one or more polymers selected from the group consisting of polysulfones, sulfonated polysulfones, polyethersulfones, sulfonated polyethersulfones, polyethers, polyetherimides, poly(styrene)s, styrene-containing copolymers selected from the group consisting of acrylonitrilestyrene copolymers, styrene-butadiene copolymers and styrene-vinylbenzylhalide copolymers, polycarbonates, cellulosic polymers selected from the group consisting of cellulose acetate, cellulose triacetate, cellulose acetate-butyrate, cellulose propionate, ethyl cellulose, methyl cellulose, and nitrocellulose, polyamides; polyimides, polyamide/imides; polyketones, polyether ketones; poly(arylene oxide)s selected from the group consisting of poly(phenylene oxide) and poly(xylene oxide); poly(esteramide-diisocyanate); polyurethanes; polyesters, polyarylates, poly(ethylene terephthalate), poly(alkyl methacrylate)s, poly(acrylate)s, poly(phenylene terephthalate); polysulfides; polymers from monomers having alpha-olefinic unsaturation selected from the group consisting of poly(ethylene), poly(propylene), poly(butene-1), poly(4-methyl pentene-1), polyvinyls, poly(vinyl chloride), poly(vinyl fluoride), poly(vinylidene chloride), poly(vinylidene fluoride), poly(vinyl alcohol), poly(vinyl esters), poly(vinyl acetate), poly(vinyl propionate), poly(vinyl pyridine)s, poly(vinyl pyrrolidone)s, poly(vinyl ether)s, poly(vinyl ketone)s, poly(vinyl aldehyde)s, poly(vinyl formal) and poly(vinyl butyral), poly(vinyl amide)s, poly(vinyl amine)s, poly(vinyl urethane)s, poly(vinyl urea)s, poly(vinyl phosphate)s, and poly(vinyl sulfate)s; polyallyls; poly(benzobenzimidazole)s; polyhydrazides; polyoxadiazoles; polytriazoles; poly(benzimidazole)s; polybenzoxazoles; polycarbodiimides; polyphosphazines; microporous polymers; and interpolymers, block interpolymers containing repeating units and grafts and blends containing any of the foregoing polymers.

37. The process of claim 27 wherein said continuous polymer matrix comprises substituted polymers having substituents selected from the group consisting of halogens, hydroxyl groups; lower alkyl groups; lower alkoxy groups; monocyclic aryl; and lower acryl groups.

38. The process of claim 27 wherein said continuous polymer matrix comprises one or more polymers selected from the group consisting of polysulfones, sulfonated polysulfones, polyethersulfones, sulfonated polyethersulfones, polyethers, polyetherimides, cellulosic polymers, polyamides, polyimides, poly(3,3′,4,4′-benzophenone tetracarboxylic dianhydride-pyromellitic dianhydride-3,3′,5,5′-tetramethyl-4,4′-methylene dianiline) (poly(BTDA-PMDA-TMMDA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-benzophenone tetracarboxylic dianhydride-3,3′,5,5′-tetramethyl-4,4′-methylene dianiline) (poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), poly[2,2′-bis-(3,4-dicarboxyphenyl)hexafluoropropane dianhydride-1,3-phenylenediamine] (poly(6FDA-m-PDA)), poly[2,2′-bis-(3,4-dicarboxyphenyl)hexafluoropropane dianhydride-1,3-phenylenediamine-3,5-diaminobenzoic acid)] (poly(6FDA-m-PDA-DABA)), poly[2,2′-bis-(3,4-dicarboxyphenyl)hexafluoropropane dianhydride-2,2-bis(3-amino-4-hydroxyphenyl)-hexafluoropropane] (poly(6FDA-bis-AP-AF)), polyamide/imides, polybenzoxazoles, polyamide/imides, polybenzoxazoles, polyketones, polyether ketones, and microporous polymers.

39. The process of claim 27 wherein said continuous polymer matrix comprises at least one polymer selected from the group consisting of polyimides, polyetherimides, polyethersulfones, polysulfones, polybenzoxazoles, cellulose acetate, cellulose triacetate, poly(vinyl alcohol)s, and microporous polymers.

40. The process of claim 27 wherein said mixed matrix membrane is used in a separation selected from the group consisting of desalination of water by reverse osmosis, deep desulfurization of gasoline or diesel fuels, ethanol/water separations, pervaporation dehydration of aqueous/organic mixtures, CO₂/CH₄, CO₂/N₂, H₂/CH₄, O₂/N², olefin/paraffin, and iso/normal paraffins separations.
